(19) United States
(12) Patent Application Publication
(10) Pub. No.: US 2017/0044794 A1
(43) Pub. Date: Feb. 16, 2017

(54) Fence connector system and method

(71) Applicant: Phillip Wake Morrow, Forest City, NC (US)

(72) Inventor: Phillip Wake Morrow, Forest City, NC (US)

(21) Appl. No.: 15/330,145

(22) Filed: Aug. 15, 2016

Related U.S. Application Data
(60) Provisional application No. 62/205,668, filed on Aug. 15, 2015.

(51) Int. Cl. E04H 17/24; B25B 13/48; E04H 17/20; E04H 17/06; E04H 17/10

(52) U.S. Cl. CPC E04H 17/24; E04H 17/06; E04H 17/10; E04H 17/20; B25B 13/48

(57) ABSTRACT

A fence connector system and/or method can include a post connection element securable to a fence support structure and comprising an outwardly extending receptacle having a bore hole; a fence receiving arm comprising (a) a head retainable in the receptacle and (b) a shaft extending from the head insertable through the receptacle bore hole and comprising a fence engaging slot adapted to receive and engage a fence wire; and a fence securing mechanism configured to secure the fence wire in the fence engaging slot. The fence receiving arm is rotatable in the receptacle and bore hole about an axis, whereby the fence wire is securable to the fence support structure in any circumferential position about the axis.

### CROSS-REFERENCE TO RELATED APPLICATION

This application claims benefit of U.S. Provisional Patent App. No. 62/205,668, filed Aug. 15, 2015, which application is incorporated by reference herein in its entirety.

### FIELD OF THE INVENTION

The present invention relates to a fence connector system and/or method.

### BACKGROUND OF THE INVENTION

In order to construct a wire fence, fence posts are secured into the ground at regular intervals, and then wire fencing is attached to the posts. Fence posts have historically been made of wood. Many fences today are constructed using metal “T-posts.” These posts have a cross-sectional “T” shape with projections or lugs extending along one surface that are used to hold barbed or other wire at a preset height along the post when secured to the post.

Wire fencing can be attached to either wood posts or metal 1-posts using one or more conventional connectors and methods. Various types of wire fencing, including wire mesh panel fencing, have typically been attached to wood posts using metal staples that are hammered about the wire and into the wood. Wire fencing has often been attached to metal 1-posts using wire, twine, cable ties, or other lashing material wrapped around the fencing and the 1-posts and tightened so as to bind the fencing to the posts.

Such conventional approaches to connecting wire fencing to fence posts have disadvantages. For example, either of these traditional methods requires use of various tools and is time-consuming. To illustrate, use of connecting materials such as twine and wire involve determining an appropriate length of material for the connection, cutting that length from a bulk supply, wrapping the material about the fencing and the post, and then tightening the twine or wire to secure the fence to the post. Using conventional fence connectors can require more than one person to keep the fencing in position relative to a post while a connector is applied.

Another disadvantage of conventional fence connectors and methods is that they can be unreliable and less durable than fence posts and wire fencing. Staples are susceptible to rust due to moisture in the environment, which can eventually lead to breakage. Also, when wood posts expand and contract in response to changing weather conditions, staples can become unattached. Wire fence connectors can rust and break, particularly at stress points where the wire is bent around a post. Likewise, fence connections made with twine are subject to relatively rapid weathering and breakage at stress points about fencing and posts. Thus, unreliable connectors can be the cause of fence failure. It is important that fencing be reliably secured to fence posts, for example, when wire mesh panel fencing is utilized as a livestock fence, so as to keep the livestock contained.

In addition, as a result of their limited durability, conventional fence connectors such as staples, wire, and twine are generally not suitable for reuse in subsequent applications.

Another disadvantage of conventional fence connectors and methods is that they do not readily accommodate installing wire mesh fence panels on any type of grade, such as a hill. Attempting to attach wire fence panels to posts on a gradient is often met with difficulty aligning the fencing with desirable points of connection on the posts. Even if fence panels are successfully attached to posts on a gradient, additional stress on conventional connectors (such as staples, wire, twine, and cable ties) from such angled attachment can accelerate deterioration and further reduce reliability and/or durability of those connectors.

Thus, there is a need for a means for quickly and easily connecting fencing to fence posts. There is a need for such a quick and easy fence connector system that is reliable. There is a need for such a quick and easy fence connector that is durable and reusable. There is a need for such a quick and easy fence connector system that is adaptable to installing fence panels on posts on a gradient.

### SUMMARY

Some embodiments of the present invention include a fence connector system, comprising a post connection element securable to a fence support structure and comprising an outwardly extending receptacle having a bore hole; a fence receiving arm comprising (a) a head retainable in the receptacle and (b) a shaft extending from the head insertable through the receptacle bore hole and comprising a fence engaging slot adapted to receive and engage a fence wire; and a fence securing mechanism configured to secure the fence wire in the fence engaging slot. The fence receiving arm is rotatable in the receptacle and bore hole about an axis, whereby the fence wire is securable to the fence support structure in any circumferential position about the axis.

In such embodiments, the fence receiving arm shaft can further include two opposed legs spaced apart from the outer end of the shaft toward the head and defining the fence engaging slot between the two legs. In some embodiments, the fence receiving arm further comprises a bolt. In a preferred embodiment, the shaft further comprises a threaded shaft, and the fence securing mechanism further comprises a nut threadable onto the shaft. The nut can be tightened on the shaft to secure the fence wire in the fence engaging slot.

In some embodiments of the fence connector system, the fence support structure comprises a T-post, and the post connection element can further comprise a post clamp positionable and securable about a plurality of points along a longitudinal axis of the T-post. In such an embodiment, the post clamp can further include a cylindrical center body sized to fit about the T-post; two opposing, spaced-apart flanges extending from the cylindrical center body opposite the receptacle, each flange comprising a bore hole; and a post clamp fastener extendable through the bore holes of the flanges and capable of being tightened to secure the post clamp to the T-post. In some embodiments, the post clamp fastener can further include a threaded screw and a threaded nut tightenable onto the screw.

In other embodiments of the fence connector system, the fence support structure comprises a wood structure, and the post connection element can further comprise a post hanger bracket. The post hanger bracket can include a flange extending at an approximately 90 degree angle from each side of the receptacle, each flange comprising a bore hole configured to receive a fastener for securing the bracket to the wood structure.

In some embodiments of the fence connector system, the fence wire can comprise a wire fence panel. In certain such embodiments, the fence engaging slot is adapted to receive and engage a plurality of the fence wires, whereby a plurality of the fence panels can be secured to the fence support structure by a single one of the fence connector system.

Some embodiments of the fence connector system can further include a protector cap securable onto an end of the shaft of the fence receiving arm after the fence wire has been secured in the fence engaging slot.

Some embodiments of the fence connector system can further include a fence connector tool. The fence connector tool can comprise an open end wrench on one end and a hex head socket wrench on the opposite end. Each end of the fence connector tool is adapted for securing either the post connection element to the fence support structure or the fence wire in the fence engaging slot.

Some embodiments of the present invention include a fence connection method, that includes providing a fence connector system comprising: a post connection element comprising an outwardly extending receptacle having a bore hole, a fence receiving arm comprising (a) a head retained in the receptacle and (b) a shaft extending from the head through the receptacle bore hole and comprising a fence engaging slot, the fence receiving arm rotatable in the receptacle and bore hole about an axis, and a fence securing mechanism configured to secure a fence wire in the fence engaging slot. Such an embodiment of a method can further include the steps of securing the post connection element to a fence support structure; rotating the fence receiving arm to a desired circumferential position; inserting the fence wire in the fence engaging slot; and securing the fence wire in the fence engaging slot with the fence securing mechanism. In this way, the fence wire can be secured to the fence support structure in the desired circumferential position. In some embodiments, the fence receiving arm shaft further includes a threaded shaft, and the fence securing mechanism further includes a nut. In such an embodiment, the method further comprises threading and tightening the nut onto the shaft to secure the fence wire in the fence engaging slot.

In some embodiments of the fence connection method, the fence support structure comprises a T-post, and the post connection element further comprises a post clamp comprising (a) a cylindrical center body sized to fit about the T-post, (b) two opposing, spaced-apart flanges extending from the cylindrical center body opposite the receptacle, each flange comprising a bore hole, and (c) a post clamp fastener comprising a threaded screw and a threaded nut. In such an embodiment, the method can further include positioning the post clamp about the T-post; inserting the screw through the bore holes of the flanges; and tightening the nut onto the screw to secure the post clamp to the T-post.

In other embodiments of the fence connection method, the fence support structure comprises a wood structure, and the post connection element further comprises a post hanger bracket comprising a flange extending at an approximately 90 degree angle from each side of the receptacle, each flange comprising a bore hole. In such an embodiment, the method can further include placing a fastener in each of the flange bore holes to secure the post hanger bracket to the wood structure.

In some embodiments, such a fence connection method can further include securing a protector cap onto an end of the shaft of the fence receiving arm after the fence wire has been secured in the fence engaging slot.

Features of a fence connector system and/or method of the present invention may be accomplished singularly, or in combination, in one or more of the embodiments of the present invention. As will be realized by those of skill in the art, many different embodiments of a fence connector system and/or method according to the present invention are possible. Additional uses, advantages, and features of the invention are set forth in the illustrative embodiments discussed in the description herein and will become more apparent to those skilled in the art upon examination of the following.

### BRIEF DESCRIPTION OF THE DRAWINGS

FIG. 1 is an exploded view of an embodiment of a fence connector system of the present invention useful for connecting a wire fence to a T-post.

FIG. 2 is a front perspective view of a fence panel connected to a metal T-post using the fence connector system shown in FIG. 1.

FIG. 3 is a front perspective view of two fence panels connected to a metal T-post using the fence connector system shown in FIG. 1.

FIG. 4 is an exploded view of an embodiment of a fence connector system of the present invention useful for connecting a wire fence to a wood post.

FIG. 5 is a perspective view of the fence connector system in FIG. 4, after assembly.

FIG. 6 is a front view of fence panel connected to a wood post using an embodiment of the fence connector system shown in FIGS. 4 and 5.

FIG. 7 is a front perspective view of a fence panel connected to a wood post using embodiments of the fence connector system shown in FIGS. 4 and 5.

FIG. 8 is a front view of a fence connector tool having an open end wrench on one end and a hex head socket wrench on the opposite end useful for attaching embodiments of the fence connector system to a post and for attaching a fence panel to the fence connector.

### DESCRIPTION

For the purposes of this description, unless otherwise indicated, all numbers expressing quantities, conditions, and so forth used in the description are to be understood as being modified in all instances by the term “about.” Accordingly, unless indicated to the contrary, the numerical parameters set forth in the following description are approximations that can vary depending upon the desired properties sought to be obtained by the embodiments described herein. At the very least, and not as an attempt to limit the application of the doctrine of equivalents to the scope of the invention, each numerical parameter should at least be construed in light of the number of reported significant digits and by applying ordinary rounding techniques.

Notwithstanding that the numerical ranges and parameters setting forth the broad scope of the described embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein.

As used in this description, the singular forms “a,” “an,” and “the” include plural referents unless the context clearly dictates otherwise. Thus, for example, the term “a fence connector” is intended to mean a single fence connector or more than one fence connector. For the purposes of this specification, terms such as “forward,” “rearward,” “front,” “back,” “right,” “left,” “upwardly,” “downwardly,” and the like are words of convenience and are not to be construed as limiting terms. Additionally, any reference referred to as being “incorporated herein” is to be understood as being incorporated in its entirety.

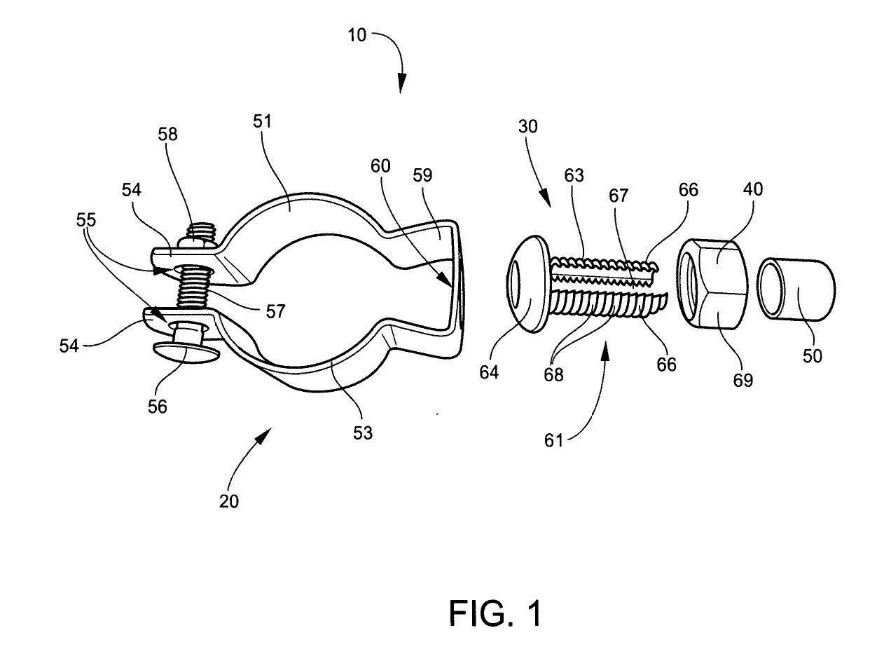

The present invention includes embodiments of a fence connector system and method. Such embodiments of a fence connector system 10 and method can comprise a post connection element 20, a fence receiving arm 30, and a fence securing mechanism 40. In some embodiments, the fence connector system 10 and method can further comprise a protector cap 50. The components of one such embodiment are shown in exploded view in FIG. 1. Embodiments of the fence connector system 10 can be secured to a fence support structure. In various embodiments, a fence support structure can comprise a metal T-post 52, a wood structure (such as a wood post 81, wood barn member, etc.), a concrete wall, or other structure capable of supporting a fence.

In the illustrative embodiment in FIG. 1, the post connection element 20 can comprise a post clamp 51. In a preferred embodiment, the post clamp 51 comprises a conduit hanger clamp that is commercially available from a number of sources. The post clamp 51 is adaptable for connecting to the metal 1-post 52. The conduit hanger post clamp 51 can comprise a piece of metal having a cylindrical center body 53 of sufficient size to fit about the 1-post 52. Extending from one side of the cylindrical center body 53 are two spaced-apart flanges 54, each including a bore hole 55. A post clamp fastener 56, such as the threaded screw 57 shown in FIG. 1, can extend through the bore holes 55 of the flanges 54. A nut 58 can be threaded onto the end of the screw 57. The fastener 56 can be tightened, for example, by threading the nut 58 further onto the screw 57, thereby causing the clamp 51 to be secured about the post 52.

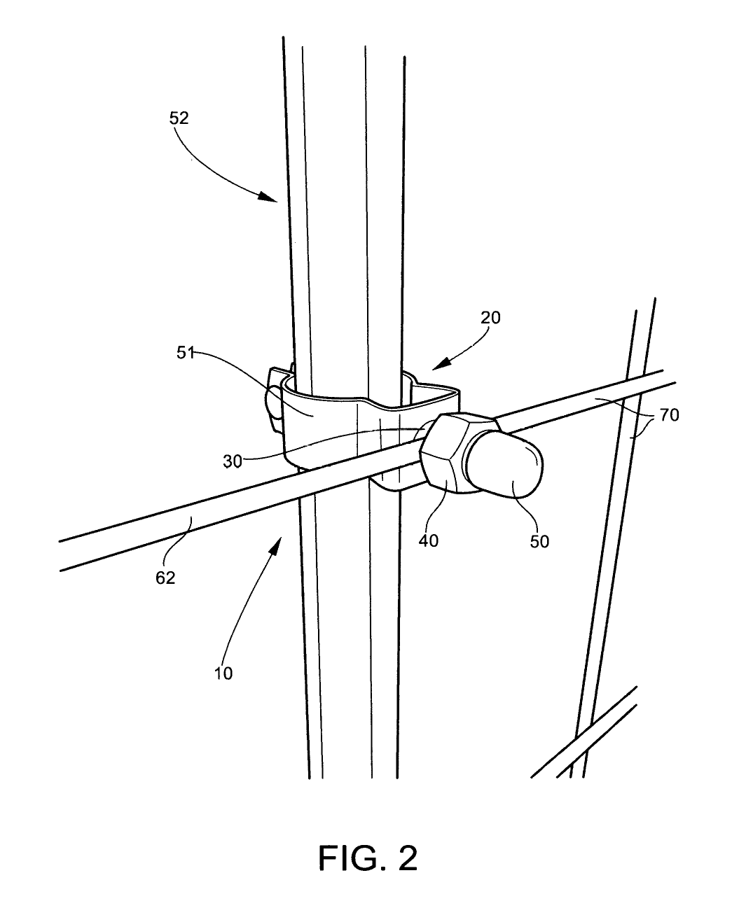

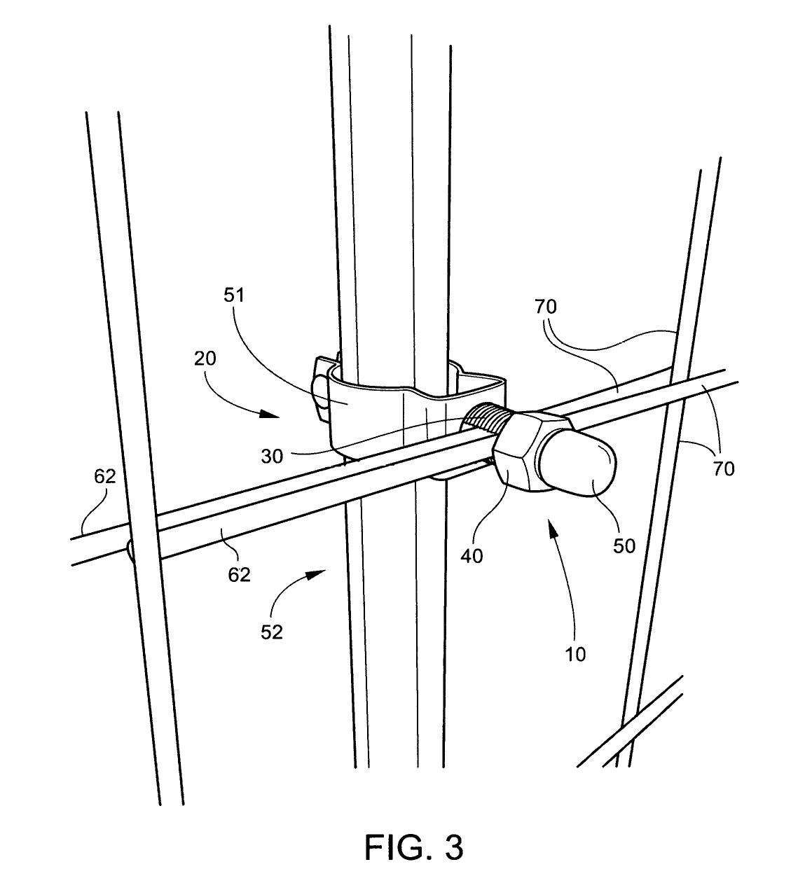

As shown in FIGS. 2 and 3, the conduit hanger post clamp 51 can be positioned about the T-post 52 at any point along the longitudinal axis of the 1-post 52 desirable for attaching a strand of fence wire 62. In some embodiments, the post clamp 51 can be slid over the end of the 1-post 52 and positioned at a desirable point along the T-post axis. In some embodiments, the post clamp 51 is sufficiently malleable, or flexible, so that the two flanges 54 can be slightly separated and the post clamp 51 positioned about the 1-post 52 without sliding the post clamp 51 over the end of the post 52. This allows positioning the fence connector system 10 at a desired location along the axis of the T-post 52, for example, after a fence panel 70 has been attached at other points. Once the post clamp 51 is in position, the post clamp fastener 56, such as the screw 57 and nut 58 shown in FIG. 1, can then be tightened to secure the post clamp 51 to the 1-post 52.

The cylindrical center body 53 extends outwardly in continuous fashion opposite the side of the two flanges 54 to form a receptacle 59 for housing a head 64 of the fence receiving arm 30. The outermost extent of the receptacle 59 includes a bore hole 60 through which a shaft 61 of the fence receiving arm 30 can be inserted, or positioned. In a preferred embodiment, the fence receiving arm 30 comprises a bolt 63 comprising the head 64 and a threaded shaft 61. The head 64 of the fence receiving arm bolt 63 is larger than the receptacle bore hole 60 so that the head 64 can be retained in position within the receptacle 59 of the post connection element 20 while the fence receiving arm shaft 61 extends through the receptacle bore hole 60 outwardly from the receptacle 59. The shaft 61 of the fence receiving arm bolt 63 can be machined so that the shaft 61 is split from the outer end of the shaft 61 toward the head 64 of the bolt 63 into two spaced-apart legs 66, leaving a hollow area between the two legs 66 that defines a fence engaging slot 67. In this way, when the fence connector system 10 is attached by the post clamp 51 to the T-post 52, a strand of the fence wire 62 can be inserted into the hollow fence engaging slot 67 of the shaft 61. Thus, the fence receiving arm 30 advantageously provides a securable enclosure for the fence wire 62 independent of the post connection element 20.

In a preferred embodiment, the fence receiving arm bolt 63 is rotatable in the bore hole 60 of the post clamp receptacle 59 when the shaft 61 of the bolt 63 is positioned through the bore hole 60. The fence receiving arm 30 can be fully rotatable, that is, the fence receiving arm 30 can he rotated 360 degrees around the full circumference of a circle. This allows the fence receiving arm bolt 63 to be positioned vertically to receive a vertical strand of the wire fence panel 70 or horizontally to receive a horizontal strand of the wire fence panel 70. Likewise, the fence receiving arm bolt 63 can be rotated, or swiveled, to any circumferential position so as to receive a strand of the wire fence 62 oriented anywhere between the vertical and horizontal axes.

“Circumferential position” means a position on the circumference, or arc, of a circle to which the radius of the circle extends from the center of the circle. In this sense, the center of the circle is the axis—essentially a point on the fence support structure—about which the fence receiving arm 30 is rotatable. Thus, by securing the fence wire 62 in the fence receiving arm 30, the fence wire 62 can be secured to the fence support structure at any angle about the fence receiving arm axis of rotation, that is, in any circumferential position about a center point of rotation on the fence support structure. This feature allows the fence connector system 10 to accommodate installation of wire fencing onto fence posts located on a gradient, such as a hill.

Embodiments of the fence connector system 10 and/or method of the present invention can include the fence securing mechanism 40. For example, as shown in FIG. 1, the shaft 61 of the fence receiving arm bolt 63 can have threads 68, or be threaded, on its outer surface. In this embodiment, the fence securing mechanism 40 can comprise a correspondingly threaded nut 69 that can be threaded onto the shaft 61 of the fence receiving arm 30. The nut 69 can be tightened onto the bolt shaft 61 so as to secure a strand of fence wire 62 in the shaft 61, and thereby secure the wire fencing 62 onto the T-post 52.

One aspect of the present invention provides the post connection element 20 that is securable to a fence support structure, such as the T-post 52, using a first mechanism (the post clamp fastener 56), and the fence receiving arm 30 that secures the fence wire 62 and fence panel 70 to a fence support structure, or post 52, by a separate second mechanism (the fence securing mechanism 40). In this way, the post connection element 20 can be completely secured in a desired position on the post 52 independently of attaching the fence wire 62 to the fence connector system 10. As a result, the post connection element 20 can be secured to the post 52 before or after the fence wire 62 is secured to the fence receiving arm 30. This feature thus allows flexibility in connecting the fence wire 62 and fence panel 70 to the post 52.

In some embodiments, the fence connector system 10 further comprises the protector cap 50. The protector cap 50 can be placed onto the end of the shaft 61 of the fence receiving arm bolt 63 that protrudes beyond the fence securing mechanism nut 69 when the nut 69 is tightened. The protector cap 50 can comprise a material, such as a resilient polymeric material and/or rubber, that is protective against injury or damage to persons, animals, or equipment near the fence.

In some embodiments of the fence connector system 10 and/or method, the fence engaging slot 67 in the shaft 61 of the fence receiving arm 30 can have a size and/or configuration that allows insertion and securement of more than one strand of the fencing wire 62. For example, as shown in FIG. 3, the ends of wires 62 of two fence panels 70 can be inserted into the fence engaging slot 67 in the fence receiving arm shaft 61. In this way, two fence panels 70 can be secured to the same T-post 52 using a single fence connector system 10.

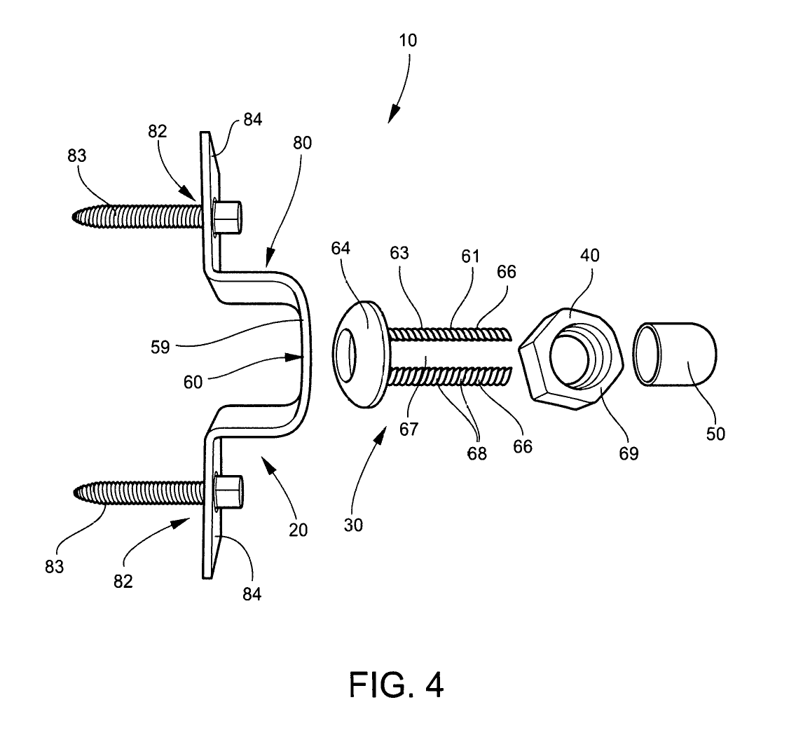

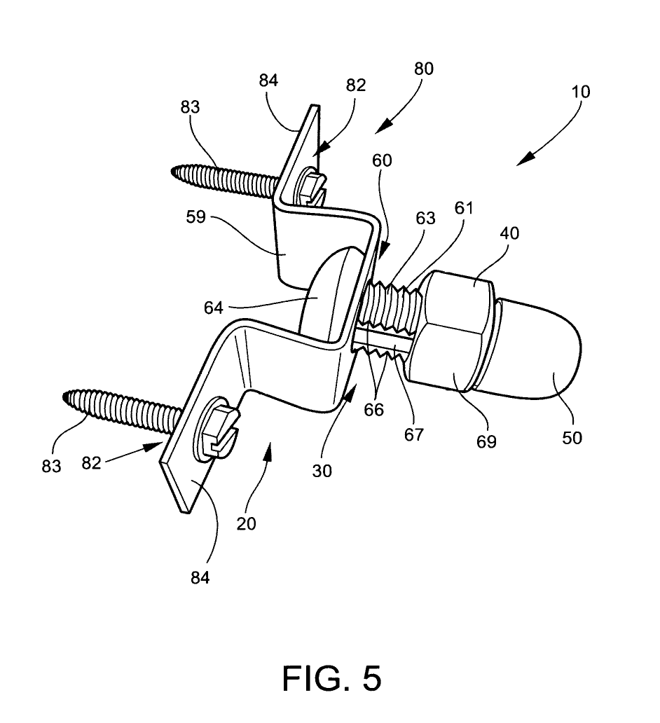

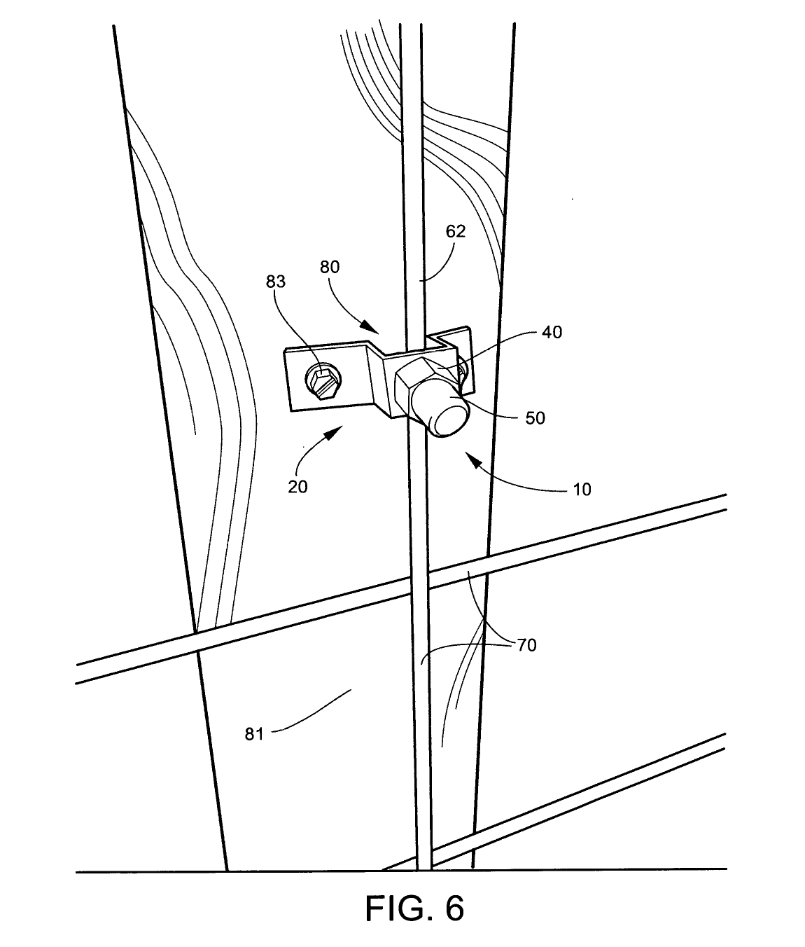

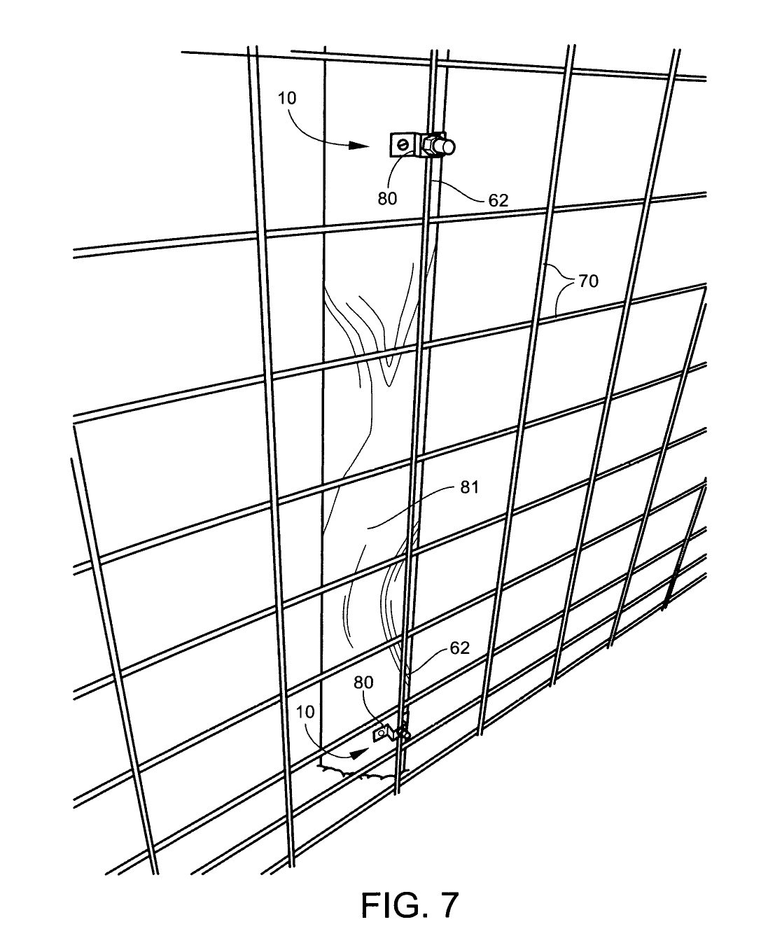

In other embodiments of the fence connector system 10 and/or method, the post connection element 20 can comprise a post hanger bracket 80, as shown in FIGS. 4 and 5. The post hanger bracket 80 can comprise a strap comprising a substantially rigid material, such as metal, and is adaptable for connecting to a wood structure, such as the wood post 81, barn siding, or tree. The post hanger bracket 80 includes the protruding center receptacle 59 for housing the head 64 of the fence receiving arm 30. The outermost extent of the receptacle 59 includes the bore hole 60 through which the shaft 61 of the fence receiving arm 30 is positioned. The post hanger bracket 80 can comprise a flange 84 extending at an approximately 90 degree angle from each side of the receptacle 59. As shown in FIGS. 4 and 5, each flange 84 can include a bore hole 82 configured to receive a fastener for securing the bracket 80 to the wood structure. The fastener can be, for example, a screw 83, one of which can be driven through each bore hole 82 to secure the bracket 80 to the wood structure, such as the wood post 81. Embodiments that comprise the post hanger bracket 80 also comprise the fence receiving arm 30 and the fence securing mechanism 40, as described herein with respect to embodiments in FIGS. 1-3. In some such embodiments, the fence connector system 10 further comprises the protector cap 50, as described herein with respect to embodiments in FIGS. 1-3. In FIGS. 6-7, an embodiment of the fence connector system 10 as shown in FIGS. 4-5, is shown connecting a wire fence panel 70 to the wood post 81.

In still other embodiments, the post connection element 20 can be configured so as to be adapted for connecting the wire fence 62/70 to other structures, for example, a concrete post. In still other embodiments, the fence connector system 10 can be configured so as to be adapted for connecting a wire in an electric fence to a structure, such as the metal T-post 52.

For purposes of the description herein, “fence wire” is considered to mean any fencing member capable of being received and secured in the fence receiving arm 30. For example, “fence wire” can mean a plain wire, a barbed wire, or a wire that is part of a section of fence panel 70, or part of a length of mesh fencing. As another example, “fence wire” can comprise a wire component of an electric fence system. A “fence panel” 70 herein means fence wire 62 formed into sections, or panels, for example, as shown in FIGS. 2, 3, 6, and 7. The fence panel 70 can comprise fence wire 62 welded at regular intervals to form a pattern. Such fence panels 70 can have various dimensions.

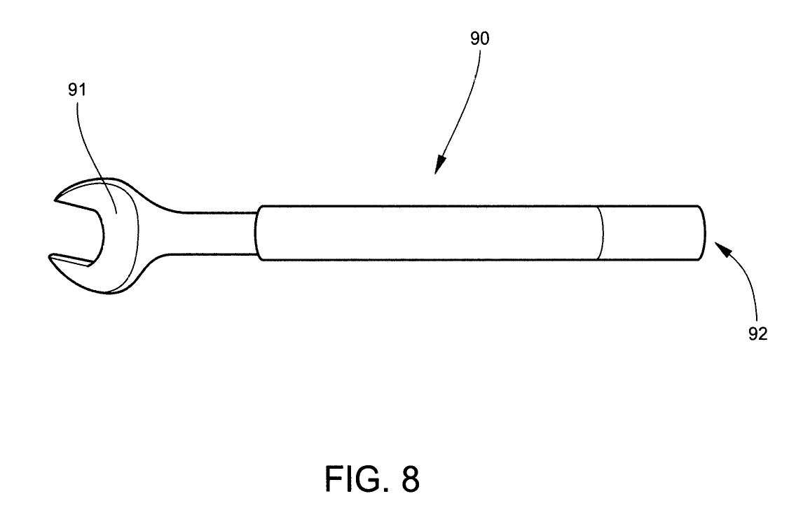

In another aspect, the present invention comprises a fence connector tool 90, as shown in FIG. 8. The fence connector tool 90 can comprise an open end wrench 91 on one end and a hex head socket wrench 92 on the opposite end. This combination of wrenches 91, 92 into one tool is useful for attaching embodiments of the fence connector system 10 to a fence support structure and for attaching the fence wire 62/fence panel 70 to the fence connector system 10. The all-in-one fence connector tool 90 facilitates quick installation of the fence connector system 10 and attachment of the fence wire 62/fence panel 70 to the fence connector system 10 by one person.

Embodiments of the fence connector system 10 and method of the present invention have various applications. For example, fencing applications utilizing the fence connector system 10 and method include those for livestock, such as cattle, horses, sheep, goats, pigs, chickens, etc. The fence connector system 10 and method can be used by home owners to quickly and easily create fencing for a dog lot or other containment area. Fencing utilizing the fence connector system 10 and method can also include applications related to growing produce, such as staking tomatoes, beans, blueberries, blackberries, and grape vines. For example, the fence panel 70 attached to T-posts 52 using an embodiment of the fence connector system 10 and method can be utilized for training plants to grow upward along the fence panels 70. The fence connector system 10 and method can also be utilized to rapidly fabricate steel support frameworks for use in concrete. Although illustrations of the fence connector system 10 described herein depict a single size of the fence connector system 10, different size fence connector systems 10 are contemplated for use in various applications, for example, with smaller or larger gauge wire panels.

Embodiments of the fence connector system 10 and method of the present invention provide numerous advantages over conventional fence connectors. For example, embodiments of the fence connector system 10 and method provide a means for quickly and easily connecting fencing to fence posts. Embodiments of the fence connector system 10 and method can be easily utilized to install wire fencing by one person.

Embodiments of the fence connector system 10 and method provide fence connectors that are reliable, particularly when it is important to avoid fence failure, for example, when wire mesh panel fencing 70 is utilized as a livestock fence.

Embodiments of the fence connector system 10 and method provide fence connectors that are more durable than conventional fence connectors (such as staples, wire, twine, or cable ties). As a result, embodiments of the fence connector system 10 can be reused in subsequent applications.

Embodiments of the fence connector system 10 and method provide for rotation of the fence receiving arm 30 so as to receive a strand of the fence wire 62 vertically, horizontally, or at any position between those two axes. Accordingly, the fence connector system 10 and method allows installation of wire fencing onto fence posts 52, 81 located on a gradient, such as a hill.

Embodiments of the fence connector system 10 and method provide fence connectors that are aesthetically appealing, particularly as compared to conventional fence connection systems.

Although the present invention has been described with reference to particular embodiments, it should be recognized that these embodiments are merely illustrative of the principles of the present invention. Those of ordinary skill in the art will appreciate that the fence connector system 10 and method of the present invention may be constructed and implemented in other ways and embodiments. Accordingly, the description herein should not be read as limiting the present invention, as other embodiments also fall within the scope of the present invention.

What is claimed is:

1. A fence connector system, comprising:
a post connection element securable to a fence support structure and comprising an outwardly extending receptacle having a bore hole;
a fence receiving arm comprising (a) a head retainable in the receptacle and (b) a shaft extending from the head insertable through the receptacle bore hole and comprising a fence engaging slot adapted to receive and engage a fence wire; and
a fence securing mechanism configured to secure the fence wire in the fence engaging slot,
wherein the fence receiving arm is rotatable in the receptacle and bore hole about an axis, whereby the fence wire is securable to the fence support structure in any circumferential position about the axis.

2. The fence connector system of claim 1, wherein the shaft further comprises two opposed legs spaced apart from the outer end of the shaft toward the head and defining the fence engaging slot between the two legs.

3. The fence connector system of claim 2, wherein the fence receiving arm further comprises a bolt.

4. The fence connector system of claim 2,
wherein the fence receiving arm shaft further comprises a threaded shaft, and
wherein the fence securing mechanism further comprises a nut threadable onto the shaft and tightenable for securing the fence wire in the fence engaging slot.

5. The fence connector system of claim 1,
wherein the fence support structure comprises a T-post, and
wherein the post connection element further comprises a post clamp positionable and securable about a plurality of points along a longitudinal axis of the T-post.

6. The fence connector system of claim 5, wherein the post clamp further comprises:
a cylindrical center body sized to fit about the T-post,
two opposing, spaced-apart flanges extending from the cylindrical center body opposite the receptacle, each flange comprising a bore hole, and
a post clamp fastener extendable through the bore holes of the flanges and capable of being tightened to secure the post clamp to the T-post.

7. The fence connector system of claim 6, wherein the post clamp fastener further comprises a threaded screw and a threaded nut tightenable onto the screw.

8. The fence connector system of claim 1,
wherein the fence support structure comprises a wood structure, and
wherein the post connection element further comprises a post hanger bracket comprising a flange extending at an approximately 90 degree angle from each side of the receptacle, each flange comprising a bore hole configured to receive a fastener for securing the bracket to the wood structure.

9. The fence connector system of claim 1, wherein the fence wire comprises a wire fence panel.

10. The fence connector system of claim 9,
wherein the fence engaging slot is adapted to receive and engage a plurality of the fence wires,
whereby a plurality of the fence panels can be secured to the fence support structure by a single one of the fence connector system.

11. The fence connector system of claim 1, further comprising a protector cap securable onto an end of the shaft of the fence receiving arm after the fence wire has been secured in the fence engaging slot.

12. The fence connector system of claim 1, further comprising a fence connector tool comprising an open end wrench on one end and a hex head socket wrench on the opposite end, each end of the tool adapted for securing one of (a) the post connection element to the fence support structure and (b) the fence wire in the fence engaging slot.

13. A fence connector system, comprising:
a post connection element securable to a fence support structure and comprising an outwardly extending receptacle having a bore hole;
a fence receiving arm comprising (a) a head retainable in the receptacle and (b) a threaded shaft extending from the head insertable through the receptacle bore hole and comprising two opposed legs spaced apart from the outer end of the shaft toward the head and defining a fence engaging slot adapted to receive and engage a fence wire; and
a fence securing mechanism comprising a nut threadable onto the shaft and tightenable for securing the fence wire in the fence engaging slot,
wherein the fence receiving arm is rotatable in the receptacle and bore hole about an axis, whereby the fence wire is securable to the fence support structure in any circumferential position about the axis.

14. A fence connection method, comprising:
providing a fence connector system comprising:
a post connection element comprising an outwardly extending receptacle having a borehole,
a fence receiving arm comprising (a) a head retained in the receptacle and (b) a shaft extending from the head through the receptacle bore hole and comprising a fence engaging slot, the fence receiving arm rotatable in the receptacle and bore hole about an axis, and
a fence securing mechanism configured to secure a fence wire in the fence engaging slot;
securing the post connection element to a fence support structure;
rotating the fence receiving arm to a desired circumferential position;
inserting the fence wire in the fence engaging slot; and
securing the fence wire in the fence engaging slot with the fence securing mechanism, thereby securing the fence wire to the fence support structure in the desired circumferential position.

15. The fence connection method of claim 14,
wherein the fence receiving arm shaft further comprises a threaded shaft, and
wherein the fence securing mechanism further comprises a nut,
the method further comprising threading and tightening the nut onto the shaft to secure the fence wire in the fence engaging slot.

16. The fence connection method of claim 14,
wherein the fence support structure comprises a T-post, and
wherein the post connection element further comprises a post clamp comprising (a) a cylindrical center body sized to fit about the T-post, (b) two opposing, spaced-apart flanges extending from the cylindrical center body opposite the receptacle, each flange comprising a bore hole, and (c) a post clamp fastener comprising a threaded screw and a threaded nut, the method further comprising:
positioning the post clamp about the T-post;
inserting the screw through the bore holes of the flanges; and
tightening the nut onto the screw to secure the post clamp to the T-post.

17. The fence connection method of claim 14,
wherein the fence support structure comprises a wood structure, and
wherein the post connection element further comprises a post hanger bracket comprising a flange extending at an approximately 90 degree angle from each side of the receptacle, each flange comprising a bore hole; the method further comprising:
placing a fastener in each of the flange bore holes to secure the post hanger bracket to the wood structure.

18. The fence connection method of claim 14, further comprising securing a protector cap onto an end of the shaft of the fence receiving arm after the fence wire has been secured in the fence engaging slot.
